(19) United States
(12) Patent Application Publication
(10) Pub. No.: US 2008/0084049 A1
(43) Pub. Date: Apr. 10, 2008

(54) Integral cushion roll retainer

(75) Inventor: James E. Nelson, Salt Lake City, UT (US)

Correspondence Address: Sally J. Brown;AUTOLIV ASP, INC., 3350 Airport Road, Ogden, UT, 84405, US

(73) Assignee: Autoliv ASP, Inc.

(21) Appl. No.: 11/544,102

(22) Filed: Oct. 6, 2006

(51) Int. Cl. B60R 21/20; B60R 21/213

(52) U.S. Cl. 280/728.2; 280/730.2

(57) ABSTRACT

A new type of inflatable cushion system in disclosed that does not need an external wrapper (or other similar feature) to maintain the cushion in the rolled configuration prior to deployment. Rather, a spot adhesive is added to an inflatable cushion as the mechanism for holding the cushion in the rolled configuration. The inflatable cushion has an inflatable region and a top edge. The spot adhesive is positioned on the top edge. This inflatable region of the inflatable cushion will also include an engagement area. In generally, the spot adhesive will engage the engagement area and holds the inflatable cushion in a rolled configuration prior to deployment. The adhesive may be double sided tape that is affixed directly to the cushion. The adhesive may also be a hook and loop fastener system, such as “Velcro” or any other suitable fastener.

### BACKGROUND OF THE INVENTION

1. The Field of the Invention

The present invention relates to a method and device for retaining an undeployed inflatable curtain airbag in a rolled or folded configuration prior to deployment.

2. The Relevant Technology

Inflatable safety restraint devices, or “airbag restraints,” are mandatory on most new vehicles. Airbag restraints commonly contain a collision sensor, and inflator, and an inflatable airbag. In the event of an accident, the collision sensor within the vehicle, such as an accelerometer, measures abnormal deceleration and triggers the inflator. The inflator is connected to the one or more airbags positioned within the vehicle. Upon receipt of the signal from the collision sensor, the inflator rapidly produces a quantity of inflation fluid or gas which fills the airbag and protects the passenger from harmful impact with the interior of the car.

One type of airbag that has received recent attention is an inflatable cushion airbag. (These airbags are sometimes referred to as “inflatable curtain airbags”). Inflatable cushion airbags have also been developed in response to the need for passenger protection from lateral impacts with the side of a vehicle's interior. This situation might occur when another vehicle collides with the side of the car, or when the car loses control and rolls over causing the side of the car to repeatedly impact the ground.

Such airbags are designed to prevent the head of an occupant in a vehicle from emerging through the window opening or from colliding with a collision surface at the side of the vehicle. The shape of the curtain airbag generally conforms to the shape of the window area or side of the car adjacent the passenger's torso. Side inflatable curtains are typically positioned above the window of the vehicle. In general, these airbags are attached to the vehicle's “roof rail” and are positioned behind the vehicle's headliner.

Because of space requirements associated with the vehicle interior, these curtain airbags are often rolled or folded into a smaller, more compact configuration for pre-deployment storage. Once these airbags have been rolled, tape may then be wrapped around the rolled airbag (“circumferential tape”) and hold it in the rolled configuration.

Other previously known systems are designed such that the rolled inflatable cushion is wrapped with a wrapper or package that will enclose the rolled airbag and secure this airbag in the rolled configuration. The wrapper will generally need some means of closure, such as tape, hook and loop fasteners (such as “Velcro”) to ensure that the wrapper does not unnecessarily open prior to deployment.

The wrapper or circumferential tape will be designed to allow deployment of the inflatable cushion in the event of an accident. Specifically, the airbag will break through the wrapper or the tape during deployment so that it may be positioned properly on the interior of the vehicle.

Using a wrapper around the exterior of the rolled inflatable cushion and/or wrapping tape around the circumference of the rolled cushion increases the effort, time and money associated with installing an inflatable cushion on a vehicle. Moreover, the costs associated with purchasing the wrapper and/or the circumferential tape will also increase the materials (and thus the costs) necessary to complete the installation process.

Accordingly, it would be an advancement in the art to provide a new type of mechanism and method for retaining an inflatable cushion airbag in a rolled configuration that would not require the use of an external wrapper or circumferential tape. Such a new method would not only make the manufacturing process easier, but also this method would provide significant cost savings to the airbag manufacturer. Such a new type of device and method is disclosed herein.

### BRIEF SUMMARY OF THE INVENTION

A new type of inflatable cushion assembly is disclosed herein. The inflatable cushion assembly includes an inflatable cushion airbag that may have a rolled configuration and an inflated, deployed configuration. Generally, the cushion is designed such that when a crash occurs, the cushion will deploy along the window and lateral side of the vehicle, thereby protecting the occupant during the crash from harmful impact with a side of the vehicle.

The cushion will generally have a top edge and an inflatable region. The inflatable region is the region of the cushion that is designed to inflate and protect the occupant. In general, the top edge is a section of the cushion proximate the upper boundary of the cushion and is located above the inflatable region. This top edge of the cushion is designed to facilitate the mounting of the cushion to the vehicle. Thus, in most embodiments, the top edge will not be inflated during deployment.

The present embodiments will also comprise a spot adhesive and an engagement area. More than one spot adhesive and/or more than one engagement area may also be used. The spot adhesive is positioned on the cushion's top edge whereas the engagement area is positioned on the inflatable region. In some embodiments, the engagement area will comprise a portion of the inflatable region.

The particular spot adhesive that is used in the present embodiments may be changed as desired. For example, in some instances, the adhesive comprises double-sided tape in which one side of the tape is affixed to the top edge of the cushion. The other edge of the tape is designed such that it may engage (i.e., be affixed to) the engagement area. In other situations, the spot may be glue that engages the engagement area on the inflatable region. In further embodiments, the adhesive may have two parts such as a hook and loop fastener (such as “Velcro”) or a snap that has one part added to the top edge and is designed to engage (affix to) the other part of the fastener at the engagement area.

The spot adhesive is designed to hold the inflatable cushion in the rolled configuration prior to deployment of the cushion. This will generally occur by having the adhesive engage the engagement area. In those embodiments in which the adhesive is double sided tape, a first side of the tape contacts and is affixed to the cushion's top edge of the cushion, whereas the second side of the tape engages the engagement area and holds the cushion in the rolled configuration.

In order to optimize the engagement between the adhesive and the engagement area, the engagement area will generally be positioned on the inflatable region such that when the cushion is rolled, the engagement area will be directly adjacent to the adhesive. Further embodiments will be designed in which the adhesive is located on a first (front) side of the cushion and the engagement area on a second (back) side of the cushion.

It should be noted that the engagement between the adhesive and the engagement area is “non-enclosing.” The term “non-enclosing” means that the mechanism for retaining the cushion in the rolled configuration does not wrap around or enclose a portion of cushion. Rather, the engagement between the adhesive and the engagement area is non-enclosing, that is, the adhesive simply contacts (and/or sticks to) the engagement area.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of an inflatable cushion assembly of the present embodiments that is shown on the interior of a vehicle, wherein the cushion is shown in the deployed configuration;

FIG. 2 is a perspective view of the inflatable cushion assembly in which the cushion is shown in the rolled configuration prior to deployment;

FIG. 3 is a cross-sectional view the inflatable cushion assembly of FIG. 1 in which the inflatable cushion is shown in the rolled configuration; and

FIG. 4 is a cross-sectional view of another embodiment of an inflatable cushion assembly of the present embodiments in which the inflatable cushion is shown in the rolled configuration

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

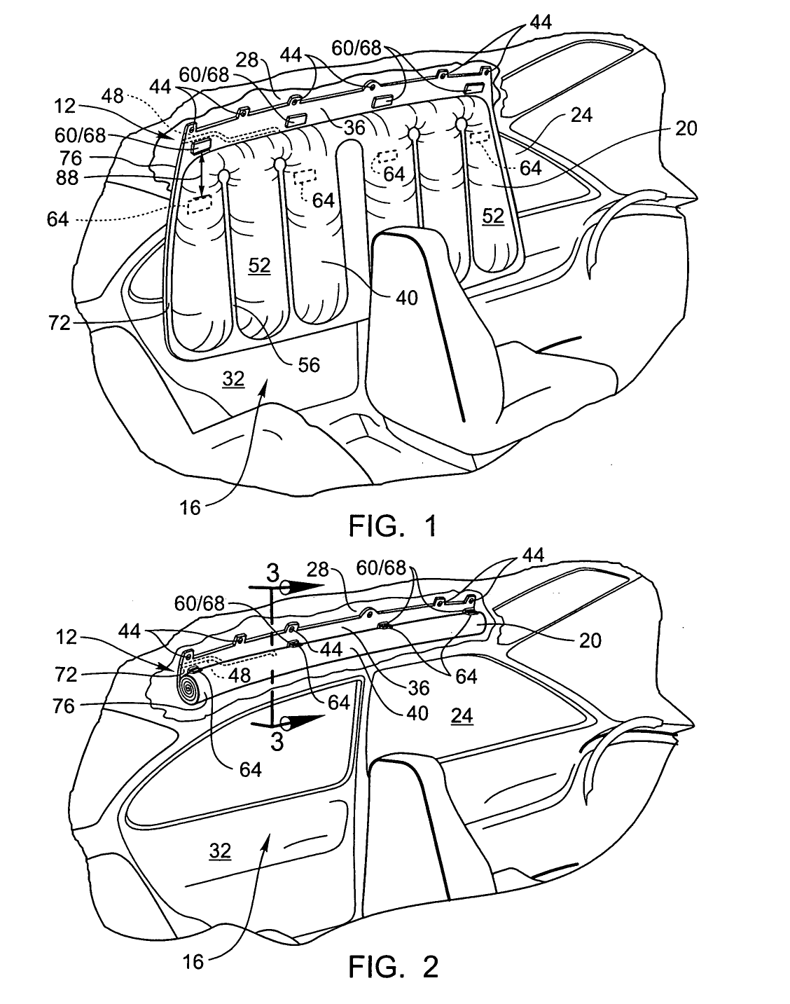

Referring now to FIGS. 1 and 2, each is a perspective view given to illustrate an inflatable cushion assembly 12 of the present embodiments that has been added within a vehicle interior 16. As is known in the art, the inflatable cushion assembly 12 includes an inflatable cushion airbag 20. The inflatable cushion 20 has a rolled configuration and a deployed, inflated configuration. As shown in FIG. 1, the cushion 20 is in the deployed, inflated configuration. However, in FIG. 2, the cushion 20 is shown in the rolled stowed configuration (prior to deployment).

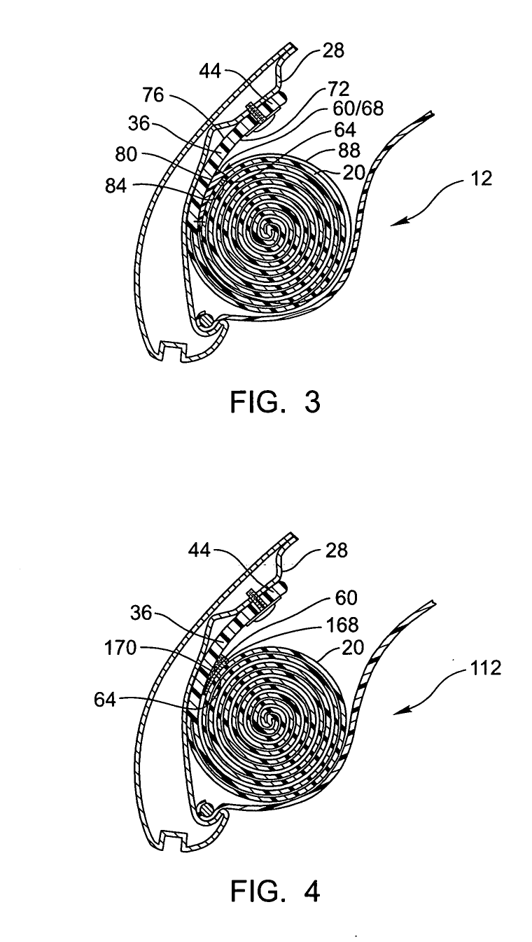

The inflatable cushion 20 is made of materials known in the art and is designed such that in the event of an accident or crash, the inflatable cushion 20 will be deployed into the vehicle interior 16. The shape of the cushion 20 generally conforms to the shape of the window area or side of the car adjacent the occupant's torso. The cushion 20 is mounted on the vehicle interior 16 above the vehicle window 24 proximate the vehicle's “roof rail” 28. (The roof rail 28 is also shown in FIGS. 3 and 4.) The cushion assembly 12 is designed such that when a crash occurs, the cushion 20 will deploy along the window 24 and lateral side 32 of the vehicle, thereby preventing the occupant from harmful contact with the vehicle's lateral side 32 and/or preventing the occupant's head from emerging through the window 24.

As shown in FIGS. 1 and 2, the inflatable cushion 20 has a top edge 36 and an inflatable region 40. In general, the top edge 36 is a section of the cushion 20 proximate the upper boundary of the cushion 20. The top edge 36 is positioned above the inflatable region 40. This portion of the cushion 20 is designed to facilitate the mounting of the cushion 20 to the roof rail 28. Accordingly, the top edge 36 will include one or more tabs 44 through which fasteners (not shown) may be passed. These fasteners connect to the roof rail 28 and secure the cushion 20 to the roof rail 28.

In order to facilitate the mounting of cushion 20, the embodiment shown in FIGS. 1 and 2 has been designed such that the top edge 36 will not be inflated during deployment of the cushion 20. Rather, the top edge 36 will simply channel the inflation gas (such as via gas guide 48) into the inflatable region 40. In most embodiments, the gas guide 48 will be attached to the inflator (not shown) as a means of channeling the supply of inflation gas into the cushion 20.

The inflatable region 40 is the portion or section of the cushion 20 that is designed to provide impact protection to the occupant. Accordingly, this is the area of the cushion 20 that will be inflated with inflation gas during deployment. As is known in the art, the inflatable region 40 may include one or more inflation chambers 52 that protect vehicle occupants. These chambers 52 may be separated by uninflatable regions 56. These uninflatable regions 56 may be seams (sewn into the cushion 20) or other features that will not be inflated by the inflation gas. Of course, the particular configuration, orientation, and arrangement of the chambers 52/uninflatable regions 56 may be modified, as desired, in order to provide optimal impact protection to the occupant(s).

As shown in FIGS. 1 and 2, the cushion assembly 12 further comprises a spot adhesive 60 and an engagement area 64. The spot adhesive 60 is positioned on the top edge 36 whereas the engagement area 64 is positioned on the inflatable region 40. In the embodiment shown in FIG. 1, the engagement area 64 will comprise a portion of the inflatable region 40. Of course, other features may also be added to the engagement area 64. As will be described in greater detail herein, the spot adhesive 60 is designed to engage the engagement area 64 as a means of holding the cushion 20 in a rolled configuration prior to deployment of the cushion 20.

As used herein, the term “spot adhesive” refers to a device or mechanism that is capable of binding the engagement area 64. Accordingly, the spot adhesive 60 may be a male fastener (such as a snap) that is designed to engage (i.e., fit into) a female receiving portion positioned at the engagement area 64. In other embodiments, the adhesive 60 may be glue that engages the engagement area 64 on the inflatable region 40. In further embodiments, the adhesive 60 may be a portion of a hook and loop fastener (such as “Velcro”) that is added to the top edge 36 and is designed to engage (affix to) a portion of the engagement area 64. In fact, in some embodiments, one portion of the hook and loop fastener (such as the hook portion) will be added as the adhesive and the second portion of the hook and loop fastener (such as the loop portion) will be added to the inflatable region 40 as the engagement area 64.

In the embodiment shown in FIGS. 1 and 2, the adhesive 60 comprises double-sided tape 68. One side of the tape 68 is affixed to the top edge 36. The other edge of the tape 68 is designed such that it may engage (i.e., be affixed to) the engagement area 64. Moreover, as shown in FIG. 1, only a single piece of tape 68 has been added to the top edge 36. Such a representation is clearly not limiting. Further embodiments may be constructed in which one or more additional adhesives 60 are added to the top edge 36. (For example, additional pieces of tape 68 may be positioned along the top edge 36.) Other embodiments may be constructed in which the entire longitudinal length of the top edge 36 comprises the adhesive 60. This embodiment could easily be constructed by simply adding a long piece of double sided tape 68 across the entire longitudinal length of the top edge 36.

It should also be noted that, in the embodiment shown in FIGS. 1 and 2, the adhesive 60 is added to a first side 72 of the cushion 20 whereas the engagement area 64 is positioned on a second side 76 of the cushion 20. More particularly, the adhesive 60 is added to the front side of the cushion 20 whereas the engagement area 64 is positioned on a back side of the cushion 20. As will be explained in greater detail herein, such positioning allows for improved engagement between the engagement area 64 and the adhesive 60.

Referring now to FIG. 3, a cross-sectional view shows the inflatable cushion assembly 12 in greater detail. FIG. 3 shows the inflatable cushion assembly 12 when the inflatable cushion 20 is in the uninflated configuration (i.e., prior to deployment). More specifically, FIG. 3 shows the cushion 20 when it is in the rolled configuration mounted on the vehicle 16 prior to deployment during an accident.

As used herein, the term “rolled configuration” refers to any type of compaction that is done to cushion 20 as part of the installation process. In general, this compaction of the cushion 20 will comprise rolling or folding the cushion 20 into a smaller bundle. However, means for compaction of the uninflated cushion 20 are also possible and fall within the meaning of the term “rolled configuration.”

As can be seen in FIG. 3, the spot adhesive 60 is designed to hold the inflatable cushion 20 in the rolled configuration prior to deployment of the cushion 20. This will generally occur by having the adhesive engage the engagement area 64. In the embodiment of FIG. 3, the adhesive 60 comprises double sided tape 68. Thus, a first side 80 of the tape 68 contacts and is affixed to the top edge 36 whereas the second side 84 of the tape 68 engages the engagement area 64 and holds the cushion 20 in the rolled configuration. Accordingly, using the inflatable cushion assembly 12 of the present embodiments, the spot adhesive 60 holds the undeployed inflatable cushion in a rolled configuration without the use of a wrapper, circumferential tape or other externally added features.

The engagement area 64 will generally be positioned on the inflatable region 40 such that the distance between the spot adhesive 60 and the engagement area 64 is generally equivalent to the circumference 88 of the rolled cushion 20. (This distance is also indicated on FIG. 1 by reference number 88). By positioning the engagement area 64 in this manner, the position of the engagement area 64 and the adhesive 60 will correspond when the cushion 20 is rolled such that there may be engagement between these two features. Such alignment of the spot adhesive 60 and the engagement area 64 will be further facilitated by having the spot adhesive 60 on the first side 72 of the cushion 20 and the engagement area 64 on the second side 76 of the cushion 20 if the cushion 20 is rolled in a counterclockwise direction. That way, as shown in FIG. 3, when the cushion 20 is rolled, the adhesive 60 and the engagement area 64 will be directly adjacent to each other. If the cushion 20 is rolled in a clockwise direction, the spot adhesive 60 may be placed on the second side 76 and the engagement area 64 on the first side 72.

It should be noted that the engagement between the adhesive 60 and the engagement area 64 is “non-enclosing.” The term “non-enclosing” means that the mechanism for retaining the cushion 20 in the rolled configuration does not wrap around or enclose a portion of cushion 20. Rather, the engagement between the adhesive 60 and the engagement area 64 is non-enclosing, that is, the only contact between the adhesive 60 and the cushion 20 occurs at the engagement area 64.

It will be readily apparent that the “non-enclosing” engagement between the adhesive 60 and the engagement area 64 is one of the ways in which the present embodiments differ from previously known airbag systems. As explained above, many currently known inflatable cushion system will use an external wrapper or a strip of tape that wraps around the circumference of the rolled cushion. These wrappers and circumferential tape enclose a portion of the cushion as the means for holding the cushion in the rolled configuration. However, in the present embodiments, there is no feature that wraps around or encloses a portion of the cushion. Rather, the adhesive 60 contacts the engagement area 64 without enclosing any portion of the cushion 20.

Referring now to FIGS. 1 through 3 collectively, the deployment of the cushion 20 will be outlined in greater detail. Specifically, as shown in FIGS. 2 and 3, the adhesive 60 will hold the cushion 20 in the rolled configuration prior to deployment. However, during deployment, the cushion 20 will inflate with the inflation gas that is channeled into the chambers 56 via the gas guide 48. This influx of gas inflates and deploys the cushion 20 into the configuration shown in FIG. 1. During this deployment, the spot adhesive 60 will separate from the inflatable region 40 and allow the inflatable region 40 to inflate and become positioned on the vehicle interior 16 that will provide impact protection to the occupant—i.e., the cushion 20 will take on the configuration shown in FIG. 1.

Referring now to FIG. 4, a second embodiment of the inflatable cushion assembly 112 is illustrated. The features, uses, and other elements of the inflatable cushion assembly 112 are similar and/or identical to the inflatable cushion assembly 12 discussed above in conjunction with FIGS. 1 through 3. However, for purposes of brevity, this discussion will not be repeated.

The main difference between the inflatable cushion assembly 12 and the inflatable cushion assembly 112 is that in the inflatable cushion assembly 112, the spot adhesive 60 does not comprise tape 68. Rather, in the embodiment shown in FIG. 4, the spot adhesive 60 comprises a first portion 168 of a hook and loop fastener system. As noted above, a hook and loop fastener system is a fastening system such as “Velcro” in which there is a hook portion and a loop portion that will engage each other. As shown in FIG. 4, the first portion 168 comprises the “hook portion” of the hook and loop fastener system. Of course, in other embodiments, the first portion 168 may be the loop portion of the system, as desired.

This first portion 168 of the hook and loop fastener system is designed to engage the engagement area 60. In some embodiments, the engagement area 64 is simply a portion of the inflatable region 40 that will engage the first portion 168. However, in other embodiments, the engagement area 64 will comprise a second portion 170 of the hook and loop fastener system. Generally, this second portion 170 will be the loop portion of the hook and loop fastener system. Accordingly, these two portions 168, 170 will contact each other and provide the appropriate engagement between the engagement area 64 and the adhesive 60 sufficient to hold the cushion 20 in the rolled configuration prior to deployment.

Referring now to FIGS. 1-4 generally, it will be readily apparent that the present embodiments also provide a method of retaining an inflatable cushion 20 to a vehicle interior 16. Specifically, the first step in the method comprises obtaining an inflatable cushion 20 having an inflatable region 40 and a top edge 36. As noted above, the inflatable region 40 will include an engagement area 64.

Once this cushion 20 has been obtained, a spot adhesive 60 will be added to the top edge 36. As explained above, this adhesive 60 may be, for example, double sided tape 68 or a portion of a hook and loop fastening system or any of a number of suitable fastening systems. Finally, the spot adhesive 60 will be brought into engagement—e.g., non-enclosing engagement—with the engagement area 64. Such engagement operates to hold the inflatable cushion 20 in a rolled configuration prior to deployment.

Further it should be noted that embodiments may be constructed in which the spot adhesive(s) 60 and/or the engagement area(s) 64, may be designed to secure the stored cushion assembly 12 and to become released during deployment of the cushion 20. In some embodiments, this “releasing” of the cushion 20 may be accomplished by choosing the right components in relation to materials and adhesive strength for the engagement area 64 and/or the spot adhesive 60. In other embodiments, this “releasing” of the cushion 20 could be accomplished by designing predetermined weakening locations (like split lines, etc.) in spot adhesive 60 and/or engagement area 64.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An inflatable cushion assembly for a vehicle comprising:
an inflatable cushion having an inflatable region and a top edge, the inflatable region having an engagement area; and
a spot adhesive positioned on the top edge, wherein the spot adhesive holds the inflatable cushion in a rolled configuration prior to deployment by engaging the engagement area in non-enclosing engagement.

2. An inflatable cushion assembly as in claim 1 wherein the top edge does not inflate during deployment of the inflatable region.

3. An inflatable cushion assembly as in claim 1, wherein the spot adhesive is releasable from the inflatable region to allow the inflatable cushion to inflate for disposition in the interior of the vehicle.

4. An inflatable cushion assembly as in claim 1 wherein the spot adhesive comprises doubled sided tape.

5. An inflatable cushion assembly as in claim 1 wherein the spot adhesive is a first portion of a hook and loop fastener system.

6. An inflatable cushion assembly as in claim 5, further comprising a second portion of a hook and loop fastener system disposed on the inflatable region at the engagement area such that the first portion and the second portion engage each other to hold the cushion in a rolled configuration.

7. An inflatable cushion as in claim 1 wherein the distance between the engagement area and the spot adhesive is generally equivalent to one circumference of the rolled inflatable cushion.

8. An inflatable cushion assembly as in claim 1 wherein the spot adhesive holds the undeployed inflatable cushion in a rolled configuration without the use of an external wrapper.

9. An inflatable cushion assembly as in claim 1 wherein the spot adhesive is positioned on a first side of the inflatable cushion and the engagement area is located on a second side of the inflatable cushion.

10. A method of retaining an inflatable cushion in a vehicle interior prior to deployment, the method comprising:
obtaining an inflatable cushion having an inflatable region and a top edge, wherein the inflatable region comprises an engagement area;
adding a spot adhesive to the top edge; and
engaging the spot adhesive to the engagement area to hold the inflatable cushion in a rolled configuration prior to deployment in non-enclosing engagement.

11. A method of retaining an inflatable cushion as in claim 10 wherein the spot adhesive is double sided tape.

12. A method of retaining an inflatable cushion as in claim 10 wherein the spot adhesive is a first portion of a hook and loop fastener system.

13. A method of retaining an inflatable cushion as in claim 12 further comprising a second portion of a hook and loop fastener system disposed at the engagement area.

14. A method of retaining an inflatable cushion as in claim 10 wherein the spot adhesive is positioned on a first side of the inflatable cushion and the engagement area is located on a second side of the inflatable cushion.

15. A method of retaining an inflatable cushion as in claim 10 wherein the distance between the engagement area and the spot adhesive is generally equivalent to one circumference of the rolled inflatable cushion.
